(19) United States
(12) Patent Application Publication
(10) Pub. No.: US 2010/0037202 A1
(43) Pub. Date: Feb. 11, 2010

(54) GENERATION OF GRAPHICAL EDITORS THROUGH META MODEL ENRICHMENT

(76) Inventor: Harald Schubert, Mannheim (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/188,904

(22) Filed: Aug. 8, 2008

(51) Int. Cl. G06F 9/44

(52) U.S. Cl. 717/105

(57) ABSTRACT

A system, method and computer program product for generating graphical editors for developing model-driven software are disclosed. A domain-specific meta model that describes one or more domain models of the software is generated. The meta model includes classes representing domain objects of each of the one or more domain models, and includes associations representing a mapping among the domain objects of each of the one or more domain models. The meta model is enriched with additional information using a profile. The classes and the associations of the meta model are annotated with tagged values based on the profile to generate an enhanced meta model. A graphical editor for developing model-driven software is then generated based on the enhanced meta model.

### FIELD

This disclosure relates generally to model-driven software development and, more particularly, to generation of graphical editors through enrichment of meta models for business process modeling.

### BACKGROUND

Model-driven software development relies on the definition of a model that can then serve as a basis for the generation of artifacts (i.e. graphics and data representing business process steps) for a target platform on which the software runs. Alternatively, the model is interpreted directly and the generation step is omitted. The benefit of the former implementation usually is a higher level of abstraction. Accordingly, defining a model is easier or faster than manually implementing the artifacts.

An example use of modeling is a business process described in Business Process Execution Language (BPEL), as opposed to a Java program that describes the business process in code. Usually, specialized tools are needed to define such models. At the meta model level, i.e. a model that describes other models, similar rules hold.

Referring back to the example of BPEL, the structure of a BPEL file underlies certain rules: each business process consists of a number of steps that can be arranged in different ways (in sequence, in parallel, in a loop, etc.). These rules are governed by what is called the meta model. Each model, i.e. a BPEL file, must comply with the rules of the meta model.

The notion of meta models is of particular interest in developing a tool that enables one to define specific kinds of models, e.g. BPEL processes. Having a formalized meta model at hand can be advantages when developing a tool for a certain type of model. The meta model, being itself a model, can be used to generate the final software.

Conventional solutions include generating Java classes that would allow for creation of in-memory models conforming to the meta model at hand. For example, having a meta model for BPEL processes can allow for generation of a set of Java classes that could then be instantiated to define a new BPEL process. Several open source tools exist in this domain, but none that are suitable for rapid application development. Accordingly, what is needed is a way to leverage a formal meta model further for getting an application implemented quickly, and allow for adaptation afterwards as needed.

### SUMMARY

The subject matter disclosed herein provides methods and apparatus, including computer program products, for generating of graphical editors for developing model-driven business process software.

In one aspect, a system for generating graphical editors for developing model-driven software is presented. In some implementations, the system includes a domain-specific meta model that describes one or more domain models of the software. The meta model includes classes representing domain objects of each of the one or more domain models, and associations representing a mapping among the domain objects of each of the one or more domain models. The system further includes a meta model enrichment tool configured to enrich the meta model with additional information using a modeling profile that contains stereotype tags for one or more of the classes of the meta model, to generate an enriched meta model. The system further includes a graphical editor generated by the enriched meta model. The graphical editor is executable by a computing system to receive user input for building software.

In yet another aspect, a computer-implemented method of generating graphical editors for developing model-driven software is presented. In some implementations, the method includes generating a domain-specific meta model that describes one or more domain models of the software, enriching the meta model with additional information using a profile. The method further includes annotating the classes and the associations of the meta model with tagged values based on the profile to generate an enhanced meta model, and generating a graphical editor for developing model-driven software based on the enhanced meta model.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 illustrates a system for generating graphical editors for model-driven business process software development.

FIG. 2 illustrates a method of generating graphical editors for model-driven business process software development.

Like reference symbols in the various drawings indicate like elements.

### DETAILED DESCRIPTION

The subject matter described herein relates to model-driven software development of business process software.

A meta model is defined for domain-specific models, such as business processes, for example. The meta model is enriched with additional information using a profile, e.g. a UML profile in case of a UML meta model. The profile contains additional stereotypes that can be used to mark classes as graphical shapes or ports, or to mark associations as graphical connections, for example. Using tagged values, the classes and associations can then be further annotated, e.g. to specify the geometry for shapes/ports, or to define the kind of connection. This information is used to generate the final graphical editor, which is then used to define process descriptions of the business process software. The generated code can be further enhanced manually.

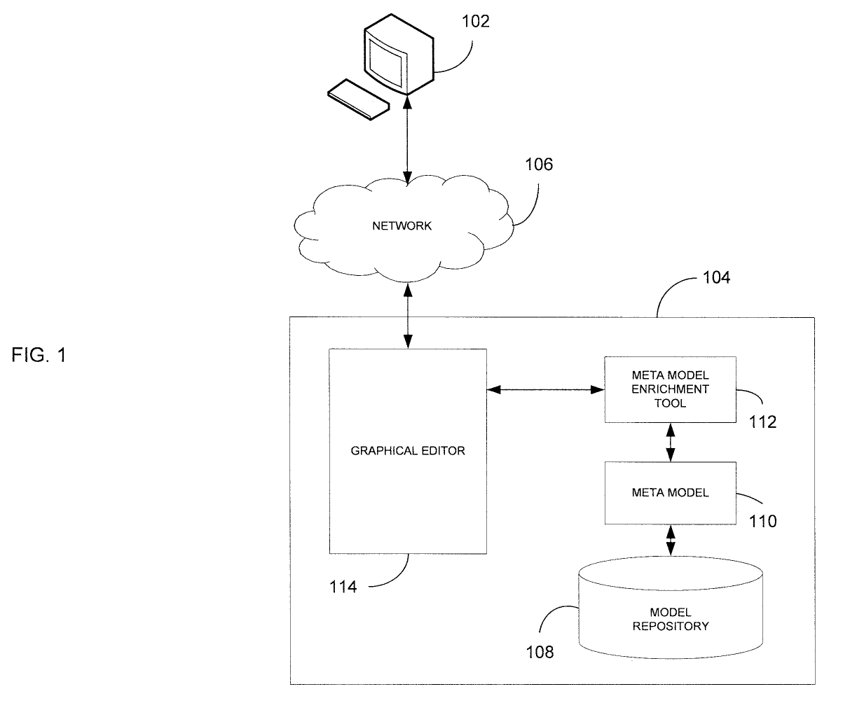

FIG. 1 shows a system 100 for model-driven business process software development. The system 100 includes a client computer 102 coupled to a server system 104 through a network 106 (e.g., the Internet or an intranet). The client system 102 and server system 104 may be implemented as one or more processors, such as a computer, a server, a blade, and the like.

The server system 104 includes a model repository 110. The model repository 110 can be organized as a database and implemented as a data warehouse, and include data structured as a snowflake schema, datacube, a star schema, or any other data structure. The model repository 110 includes structured data, such as data types, business objects, services and the like. The term “data type” refers to a data definition and its structure including at least one of data and related metadata, while the phrase “business object” and “service” refers to an object and its method used in connection with a business process or a task. In an exemplary implementation, the model repository 108 includes one or more domain models that act as a workflow gateway for data needed by a runtime system, and may include one or more graphical models that represents the graphical objects that provide a visualization of the workflow, as created by a graphical editor 114.

The server 104 further includes a domain-specific meta model 110 that describes the one or more domain models. The meta model 110 includes classes representing domain objects of each of the one or more domain models, such as a mark for representing a class as a particular graphical shape or as a port. The meta model further includes associations representing a mapping among the domain objects of each of the one or more domain models, such as a representation as a graphical connection, for example.

The server 104 further includes a meta model enrichment tool 112 that is configured to enrich the meta model 110 with additional information to generate an enriched meta model. The meta model enrichment tool 112 uses a modeling profile for the additional information. The modeling profile contains stereotype tags for one or more of the classes of the meta model. The graphical editor 114 is generated by the enriched meta model. The graphical editor 114 is executable by a computing system such as client computer 102 through network 106 to receive user input for building business process software.

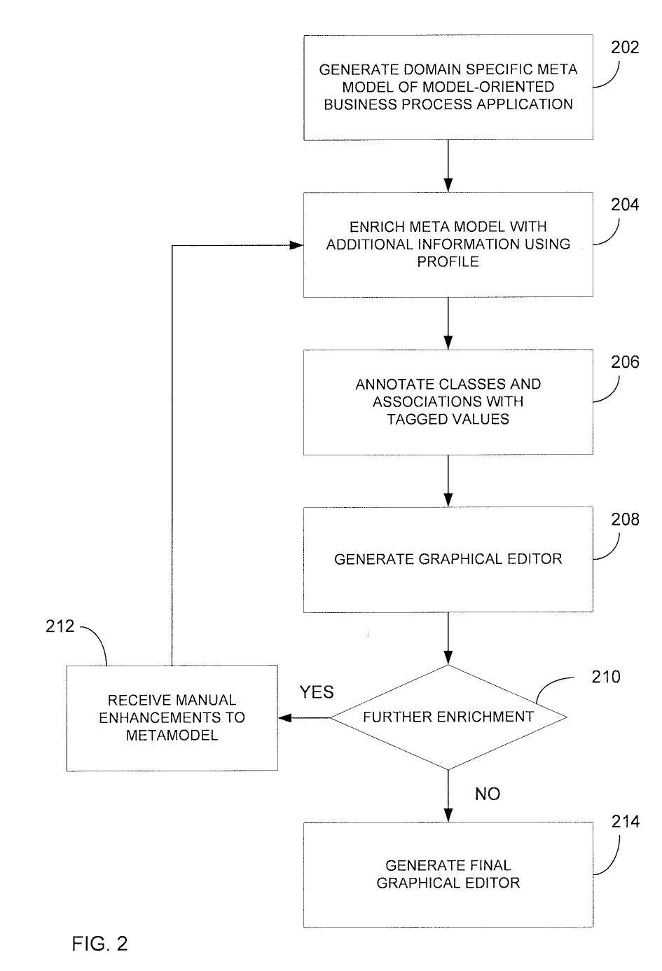

FIG. 2 illustrates a method 200 for model-driven software development, for execution preferably by a computing system such as a server connected to one or more client computers through a network. At 202, a domain-specific meta model is generated. The meta model describes domain models of a model-oriented application. The meta model includes classes that represent domain objects of each of the one or more domain models, and can further include associations representing a mapping among the domain objects of each of the one or more domain models.

At 204, the meta model is enriched with additional information using a profile. For example, UML class to be mapped to a graphical shape can be specified, and an additional tag could specify what kind of shape: rectangle, rounded rectangle, circle, ellipsis, polygon, etc. Or, in the case that UML association should be mapped to a graphical connection, an additional tag could specify the line style (dotted vs. dashed vs. solid line) or routing style (Manhattan, bendpoint-based, straight, curved). In yet another example, if a UML class should be mapped to a graphical shape that can contain other shapes, i.e. a kind of graphical container, again, information about the visual appearance of the shape might be added. Or, if a UML class should be mapped to a graphical shape that attached to another shape, i.e. a kind of “port” (such as UML component diagrams or SAP Visual Composer diagrams, for example), information about the visual appearance of the shape might be added.

At 206, the classes and associations of the domain model are annotated with tagged values and additional semantics related to the additional information and profile, to generate an enhanced meta model At 208, a graphical editor for the model-driven business process software is generated, using the enhanced meta model. The graphical editor can be run on one or more of the client computers, and operated by a user to create graphical representations of models of the domain of the software.

The meta model can also be enhanced as described at 204, with additional information using new profiles, and then annotated as described above, to generate a final graphical editor at 214. Further regeneration steps overwrite the manual changes, and must be differentiated manually.

The systems and methods described herein can be used for rapid application development of graphical editors based on a formal meta model. The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although the description above refers to a client and a server, other frameworks and architectures may be used as well. For example, the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components.

As used herein, the term “user” may refer to any entity including a person or a computer.

The foregoing description is intended to illustrate but not to limit the scope of the invention, which is defined by the scope of the appended claims. Other embodiments are within the scope of the following claims.

What is claimed is:

1. A system for generating graphical editors for developing model-driven software, the system comprising:
a domain-specific meta model that describes one or more domain models of the software, the meta model including classes representing domain objects of each of the one or more domain models, and including associations representing a mapping among the domain objects of each of the one or more domain models;
a meta model enrichment tool configured to enrich the meta model with additional information using a modeling profile that contains stereotype tags for one or more of the classes of the meta model, to generate an enriched meta model; and
a graphical editor generated by the enriched meta model, the graphical editor being executable by a computing system to receive user input for building software.

2. The system in accordance with claim 1, further comprising a model repository storing the one or more domain models defined for a domain of the model-driven software.

3. The system in accordance with claim 2, wherein the model repository, the meta model, and the meta model enrichment tool are hosted by a server computing system.

4. The system in accordance with claim 1, further comprising a client computer that is adapted to run the graphical editor through a network that connects to a server computer that hosts the meta model enrichment tool.

5. The system in accordance with claim 1, further comprising a client computer configured to receive user input to further enhance the enhanced meta model.

6. The system in accordance with claim 5, wherein the enhanced metal model is hosted by a server computer connected to the client computer via a network.

7. A computer-implemented method of generating graphical editors for developing model-driven software, the method comprising:
generating a domain-specific meta model that describes one or more domain models of the software, the meta model including classes representing domain objects of each of the one or more domain models, and including associations representing a mapping among the domain objects of each of the one or more domain models;
enriching the meta model with additional information using a profile;
annotating the classes and the associations of the meta model with tagged values based on the profile to generate an enhanced meta model; and
generating a graphical editor for developing model-driven software based on the enhanced meta model.

8. The method in accordance with claim 7, further comprising storing the one or more domain models in a model repository.

9. The method in accordance with claim 8, wherein the model repository, the meta model, and the enriched meta model are hosted by a server computing system.

10. The method in accordance with claim 7, further comprising receiving user input from a client computer, the user input representing further enhancement of the enhanced meta model.

11. The method in accordance with claim 10, further comprising generating a final enhanced meta model based on the further enhancement.

12. The method in accordance with claim 10, wherein the further enhancement includes additional stereotypes of the classes and associations as represented by the user input.

13. A computer-readable medium containing instructions to configure a processor to perform a method, the method comprising:
generating a domain-specific meta model that describes one or more domain models of software,;
enriching the meta model with additional information using a profile;
annotating the meta model with tagged values based on the profile to generate an enhanced meta model; and
generating a graphical editor for developing the model-driven software based on the enhanced meta model.

14. The method in accordance with claim 13, wherein the meta model includes classes representing domain objects of each of the one or more domain models, and including associations representing a mapping among the domain objects of each of the one or more domain models.

15. The method in accordance with claim 13, wherein annotating the meta model includes annotating the classes and associations of the meta model with tagged values based on the profile.
